(19) United States
(12) Patent Application Publication
(10) Pub. No.: US 2023/0300769 A1
(43) Pub. Date: Sep. 21, 2023

(54) METHOD AND APPARATUS FOR DETERMINING TIMING ADVANCE VALUE

(71) Applicant: LENOVO (BEIJING) LIMITED, BEIJING (CN)

(72) Inventors: HONGMEI LIU, BEIJING (CN); ZHI YAN, BEIJING (CN); YUANTAO ZHANG, BEIJING (CN); LIANHAI WU, BEIJING (CN); HAIMING WANG, BEIJING (CN)

(21) Appl. No.: 18/040,635

(22) PCT Filed: Aug. 6, 2020
(86) PCT No.: PCT/CN2020/107429

§ 371 Date: Feb. 3, 2023

(51) Int. Cl. H04W 56/00

(52) U.S. Cl. CPC H04W 56/0045

(57) ABSTRACT

Embodiments of the present disclosure relate to methods and apparatuses for determining a timing advance value. According to some embodiments of the present disclosure, a method includes: receiving, from a second node at a third node, information related to a timing advance (TA) value for uplink transmissions, wherein the second node is a parent node of the third node; and determining a first TA value for uplink transmissions based on the information.

### TECHNICAL FIELD

Embodiments of the present disclosure generally relate to wireless communication technology, especially to timing advance (TA) value determination and indication.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), 3GPP is envisioning an integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is relatively beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for determining and indicating a timing advance (TA) value in the IAB network.

### SUMMARY

An embodiment of the present disclosure provides a method. The method may include: receiving, from a second node at a third node, information related to a timing advance (TA) value for uplink transmissions, wherein the second node is a parent node of the third node; and determining a first TA value for uplink transmissions based on the information.

Another embodiment of the present disclosure provides a method. The method may include: transmitting, from a second node to a third node, information related to a timing advance (TA) value for uplink transmissions at the third node, wherein the second node is a parent node of the third node.

Another embodiment of the present application provides an apparatus. The apparatus includes: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry. The computer-executable instructions cause the at least one processor to implement any of the above-mentioned methods.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present disclosure;

FIG. 2 illustrates exemplary timing relations in a wireless communication system according to some embodiments of the present disclosure;

FIG. 3 illustrates a flow chart of an exemplary procedure for determining a TA value according to some embodiments of the present disclosure;

FIG. 4 illustrates a flow chart of an exemplary procedure for selecting a TA value according to some embodiments of the present disclosure;

FIG. 5 illustrates an exemplary periodic TA value selection scheme according to some embodiments of the present disclosure;

FIG. 6 illustrates a flow chart of an exemplary procedure for selecting a TA value according to some embodiments of the present disclosure;

FIG. 7 illustrates an exemplary TA value selection scheme according to some embodiments of the present disclosure;

FIG. 8 illustrates a flow chart of an exemplary procedure for determining a TA value according to some embodiments of the present disclosure; and

FIG. 9 illustrates a block diagram of an exemplary apparatus according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

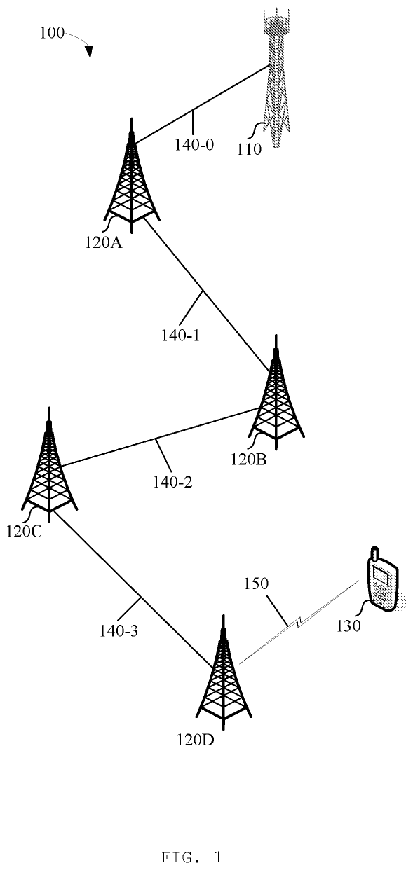

FIG. 1 is a schematic diagram illustrating an exemplary wireless communication system 100 according to some embodiments of the present disclosure.

As shown in FIG. 1, the wireless communication system 100 may include a base station (e.g., BS 110), some IAB nodes (e.g., IAB node 120A, IAB node 120B, IAB node 120C, and IAB node 120D), and a UE (e.g., UE 130). Although a specific number of UEs, IAB nodes, and BSs are depicted in FIG. 1, it is contemplated that any number of UEs, IAB nodes, and BSs may be included in the wireless communication system 100.

The UE 130 may be any type of device configured to operate and/or communicate in a wireless environment. For example, the UE 130 may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, the UE 130 may include may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE 130 may include wearable devices, such as smart watches, fitness bands, optical head-mounted displays, internet-of-things (IoT) devices, or the like. Moreover, the UE 130 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 110 may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as a gateway for the UEs to access a public switched telephone network (PSTN) and/or other networks (not shown in FIG. 1).

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

Persons skilled in the art should understand that as technology develops and advances, the terminologies described in the present disclosure may change, but should not affect or limit the principles and spirit of the present disclosure.

Referring to FIG. 1, IAB node 120A can be directly connected to BS 110. IAB node 120B can reach BS 110 by hopping through IAB node 120A. IAB node 120A is a parent IAB node of IAB node 120B. In other words, IAB node 120B is a child IAB node of IAB node 120A.

IAB node 120C can reach BS 110 by hopping through IAB node 120B and IAB node 120A. IAB node 120D can reach BS 110 by hopping through IAB node 120C, IAB node 120B, and IAB node 120A. IAB node 120A and IAB node 120B may be upstream IAB nodes of IAB node 120C, and IAB node 120B may be a parent IAB node of IAB node 120C. IAB node 120A, IAB node 120B, IAB node 120C may be upstream IAB nodes of IAB node 120D, and IAB node 120C may be a parent IAB node of IAB node 120D. IAB node 120B, IAB node 120C, IAB node 120D may be downstream IAB nodes of IAB node 120A. IAB node 120C and IAB node 120D may be downstream IAB nodes of IAB node 120B. IAB node 120D may be a downstream IAB node of IAB node 120C.

User equipment (UE) 130 can be connected to IAB node 120D. In other words, UE 130 may be served by IAB node 120D. IAB node 120B, IAB node 120C, IAB node 120D, and UE 130 may be downstream nodes of IAB node 120A. IAB node 120C, IAB node 120D, and UE 130 may be downstream nodes of IAB node 120B.

Each of BS 110, IAB node 120A, IAB node 120B, IAB node 120C, and IAB node 120D may be directly connected to one or more UEs in accordance with some other embodiments of the present disclosure. Each of BS 110, IAB node 120A, IAB node 120B, IAB node 120C, and IAB node 120D may be directly connected to one or more IAB node(s) in accordance with some other embodiments of the present disclosure.

Each of the IAB node 120A, IAB node 120B, IAB node 120C, and IAB node 120D may include a distributed unit (DU) and a mobile termination (MT). In the context of this disclosure, MT is referred to as a function resided in an IAB node that terminates the radio interface layers of the backhaul Uu interface toward an IAB donor or other IAB nodes. The IAB nodes may be connected to an upstream IAB node or a BS (e.g., an IAB donor) via the MT function. The IAB nodes may be connected to UEs and a downstream IAB node via the DU.

In an IAB deployment such as the wireless communication system 100, a BS (e.g., BS 110 in FIG. 1) may also be referred to as an IAB donor or a donor node. The radio link between a BS (e.g., BS 110 in FIG. 1) and an IAB node or between two IAB nodes may be referred to as a backhaul link (BL). The radio link between a BS (e.g., BS 110 in FIG. 1) and a UE or between an IAB node and a UE may be referred to as an access link (AL). For example, in FIG. 1, radio links 140-0 to 140-3 are BLs and radio link 150 is an AL.

In the wireless communication system 100 of FIG. 1, IAB node 120 A has the following links to support: downlink (DL) receive (Rx) over link 140-0 from the BS 110, uplink (UL) transmit (Tx) over link 140-0 to the BS 110; and UL Rx over link 140-1 from the child IAB node 120B, DL Tx over link 140-1 to the child IAB node 120B. Similarly, IAB node 120B has the following links to support: DL Rx over link 140-1 from the parent IAB node 120A, UL Tx over link 140-1 to the parent IAB node 120A; and UL Rx over link 140-2 from the child IAB node 120C, DL Tx over link 140-2 to the child IAB node 120C. IAB node 120C has the following links to support: DL Rx over link 140-2 from the parent IAB node 120B, UL Tx over link 140-2 to the parent IAB node 120B; and UL Rx over link 140-3 from the child IAB node 120D, DL Tx over link 140-3 to the child IAB node 120D.

The RANP objective for 3GPP release 17 (R17) IAB work item description (WID) includes:
Duplexing enhancements [RAN1-led, RAN2, RAN3, RAN4]:
   Specification of enhancements to the resource multiplexing between child and parent links of an IAB node, including:
      Support of simultaneous operation (transmission and/or reception) of IAB node's child and parent links (i.e., MT Tx/DU Tx, MT Tx/DU Rx, MT Rx/DU Tx, MT Rx/DU Rx).
      Support for dual-connectivity scenarios defined by RAN2/RAN3 in the context of topology redundancy for improved robustness and load balancing.
   Specification of IAB node timing mode(s), extensions for DL/UL power control, and cross link interference (CLI) and interference measurements of BH links, as needed, to support simultaneous operation (transmission and/or reception) by IAB node's child and parent links.

Regarding IAB node synchronization and timing alignment, seven different TX and RX timing configurations (i.e., case #1-case #7) for different links were considered in 3GPP TR 38.874. Methods and apparatuses according to embodiments of the present application are related to the following three cases:

Case #1 concerns DL transmission timing alignment across IAB nodes and IAB donors. If DL Tx and UL Rx are not well aligned at the parent node, additional information about the alignment is needed for the child node to properly set its DL TX timing for over-the-air (OTA) based timing and synchronization.

Case #6 concerns DL transmission timings aligned across IAB nodes and IAB donors and UL transmission timings aligned within an IAB node. The DL transmission timing for all IAB nodes is aligned with the parent IAB node or donor DL timing. The UL transmission timing of an IAB node can be aligned with the IAB node's DL transmission timing.

Case #7 concerns DL transmission timing alignment across IAB nodes and IAB donors and UL reception timings aligned within an IAB node. The DL transmission timing for all IAB nodes is aligned with the parent IAB node or donor DL timing. The UL reception timing of an IAB node can be aligned with the IAB node's DL reception timing. If DL TX and UL RX are not well aligned at the parent node, additional information about the alignment is needed for the child node to properly set its DL TX timing for OTA based timing and synchronization.

All three above configurations include synchronized DL transmissions across the nodes so that the network appears synchronized for the UEs. The following is a summary of the three timing cases:
1) case #1 timing
   Child link's DL Tx is aligned with parent link's DL Tx
      Existence of T_delta is considered to be aligned
   Child link's UL Rx is aligned with child link's DL Tx
   Can be used for time division multiplexing (TDM) among different hops
2) case #6 timing
   Child link's DL Tx is aligned with parent link's (e.g., link 140-1 in FIG. 1) DL Tx
   Child link's UL Tx is aligned with child link's DL Tx
      Can be used for space division multiplexing (SDM) and/or frequency division multiplexing (FDM) between child link (e.g., link 140-2 in FIG. 1) and grandchild link (e.g., link 140-3 in FIG. 1)
3) case #7 timing
Child link's DL Tx is aligned with parent link's DL Tx
Child link's UL Rx is aligned with parent link's DL Rx
Can be used for SDM and/or FDM between child link (e.g., link 140-2 in FIG. 1) and parent link (e.g., link 140-1 in FIG. 1)

Regarding the indication of the value of “T_delta,” NR release 16 (R16) stipulates: “in order to align the DL TX timing of the IAB node with the DL TX timing of the parent node by setting DL TX timing of the IAB node (T_{A}/2+T_delta) ahead of its DL Rx timing, T_delta should be set to the (−½) of time interval at the parent node between the start of UL RX frame i for the IAB node and the start of DL TX frame i.”

In the above three cases, case #1 is specified in NR R16. case #6 and case #7 are to be supported in NR release 17 (R17) to support SDM/FDM among different hops in an IAB network. Embodiments of the present application provide solutions to support the above timing cases. Some embodiments of the present application provide methods and apparatus for determining timing advance (TA) values in the above three cases. Some embodiments of the present application provide methods and apparatus for selecting or indicating the TA values. More details on the embodiments of the present disclosure will be illustrated in the following text in combination with the appended drawings.

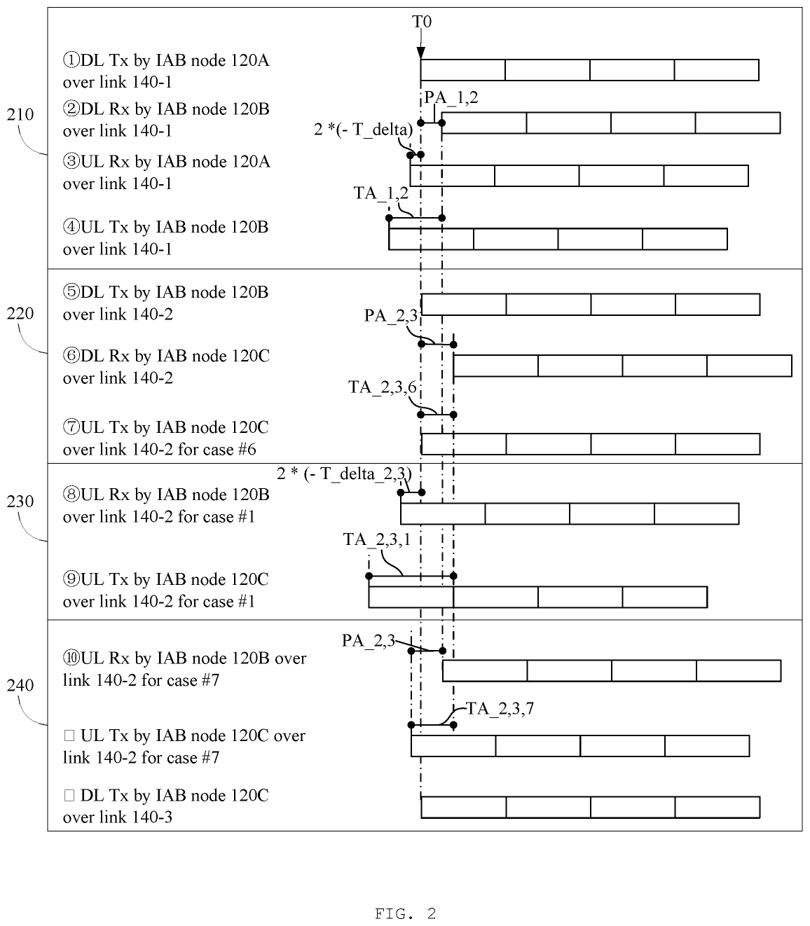

FIG. 2 illustrates exemplary timing relations in a wireless communication system according to some embodiments of the present disclosure. For example, the timing relations shown in FIG. 2 may be applied to the wireless communication system 100 in FIG. 1. Based on the timing relations in FIG. 2, TA values for link 140-2 as shown in FIG. 1 under different timing cases can be determined.

Referring to FIG. 2, none of case #1, case #6, and case #7 may be adopted at box 210. In this case, assuming that IAB node 120A performs a DL transmission over link 140-1 at time T0 (e.g., “\textcircled{1}DL Tx by IAB node 120A over link 140-1” in box 210), IAB node 120B may receive the DL transmission after a propagation delay (PA_1,2) for link 140-1 (e.g., “\textcircled{2}DL Rx by IAB node 120B over link 140-1” in box 210). To align the UL reception and DL transmission by IAB node 120A over link 140-1, a conversion time may be considered. For example, as shown in FIG. 2, the UL reception by IAB node 120A may start at T0−2×(−T_delta) (e.g., “\textcircled{3}UL Rx by IAB node 120A over link 140-1” in box 210). The UL transmission by IAB node 120B over link 140-1 may start at T0+PA_1,2−TA_1, 2 (e.g., “\textcircled{4}UL Tx by IAB node 120B over link 140-1” in box 210). TA_1, 2 may denote the timing advance value between IAB node 120A and IAB node 120B.

In all three cases, i.e., case #1, case #6, and case #7, DL transmissions at IAB nodes are aligned. For example, referring to FIG. 2, “\textcircled{1}DL Tx by IAB node 120A over link 140-1” in box 210, “\textcircled{5}DL Tx by IAB node 120B over link 140-2” in box 220, and “\textcircled{12}DL Tx by IAB node 120C over link 140-3” in box 240 are aligned.

Due to a propagation delay (PA_2,3) for link 140-2, IAB node 120C may receive the DL transmission from IAB node B after the propagation delay (PA_2,3) for link 140-2 (e.g., “\textcircled{6}DL Rx by IAB node 120C over link 140-2” in box 220).

In case #1, UL reception at an IAB node is aligned with the DL transmission at the IAB node. For example, referring to FIG. 2, “\textcircled{5}DL Tx by IAB node 120B over link 140-2” in box 220 and “\textcircled{8}UL Rx at IAB node 120B over link 140-2 for case #1” in box 230 are aligned by taking the conversion time into account. For example, the UL reception by IAB node 120B over link 140-2 may start at T0−2×(−T_delta_2,3). The timing advance value between IAB node 120B and IAB node 120C in case #1 may be denoted by TA_2,3,1. So, at “\textcircled{9}UL Tx by IAB node 120C over link 140-2 for case #1” in box 230, TA_2,3,1 can be determined by the following equation (1):

TA_2,3,1=2×PA_2,3+2×(−T_delta_2,3) (1)

According to equation (1), TA_2,3,1 contains both impacts of PA_2,3 and T_delta_2,3. In NR R15, TA_2,3,1 may be indicated in random access response (RAR) and medium access control (MAC) control element (CE). As mentioned above, PA_2,3 is the propagation delay between IAB node 120B and IAB node 120C for link 140-2. T_delta_2,3 may be the T_delta value indicated in medium access control (MAC) control element (CE) for indicate the timing difference between DL Tx and UL Rx at IAB node 120B for link 140-2. According to NR R16 agreements, T_delta_2,3=DL Tx timing at IAB node 120B—UL Rx timing at IAB node 120B for link 140-2. Although TA_2,3,1 is impacted by both PA_2,3 and T_delta_2,3, only a single TA value TA_2,3,1 is indicated to determine the UL Tx timing for case #1. So the TA value to determine the UL Tx timing in case #1 can be based on the mechanism specified in NR R15.

In case #6, UL transmission at an IAB node is aligned with the DL transmission at the IAB node (as well as the DL transmission at the upstream and downstream IAB nodes). For example, referring to FIG. 2, “\textcircled{5}DL Tx by IAB node 120B over link 140-2” in box 220 and “\textcircled{7}UL Tx by IAB node 120C over link 140-2 for case #6” in box 220 are aligned. In this example, no conversion time is needed. The timing advance value between IAB node 120B and IAB node 120C in case #6 may be denoted by TA_2,3,6. So, at “\textcircled{7}UL Tx by IAB node 120C over link 140-2 for case #6” in box 220, TA_2,3,6 can be determined by the following equation (2):

TA_2,3,6=PA_2,3=TA_2,3,1/2+T_delta_2,3 (2)

As explained above, in case #6, the UL Tx timing for link 140-2 (i.e., UL Tx at IAB node 120C) is the same as the DL Tx timing for IAB node 120C, and is also the same as the DL Tx timing for IAB node 120B, so the TA value can be determined by the TA value for link 140-2 and the T delta value for link 140-2. The necessary signaling is the same as the DL Tx timing determination for case #1 in NR R16. So the TA value to determine the UL Tx timing in case #6 can be based on the mechanism specified in NR R16.

In case #7, UL reception at an IAB node is aligned with the DL reception at the IAB node. For example, referring to FIG. 2, “\textcircled{2}DL Rx by IAB node 120B over link 140-1” in box 210 and “\textcircled{10}UL Rx by IAB node 120B over link 140-2 for case #7” in box 240 are aligned. The timing advance value between IAB node 120B and IAB node 120C in case #7 may be denoted by TA_2,3,7. So, at “\textcircled{11}UL Tx by IAB node 120C over link 140-2 for case #7” in box 240, TA_2,3,7 can be determined by the following equation (3):

TA_2,3,7=2×PA_2,3−PA_1,2=2×(TA_2,3,1/2+T_delta_2,3)−PA_1,2 (3)

In equation (3), TA_2,3,1 is the TA value introduced in NR R15 for link 140-2, and T delta_2,3 is the T delta value introduced in NR R16 for link 140-2. Therefore, the value PA_1,2 (i.e., the propagation delay for link 140-1) is required for the calculation of the TA value to determine the UL Tx timing for case #7.

Therefore, in order to support case #7, in some embodiments of the present application, the propagation delay (e.g., PA_1,2) for the parent link (e.g., link 140-1 in FIG. 1) of an IAB node (e.g., IAB node 120B in FIG. 1) may be indicated to the IAB node's child node (e.g., IAB node 120C in FIG. 1) to determine the UL Tx timing for the child node (e.g., IAB node 120C in FIG. 1).

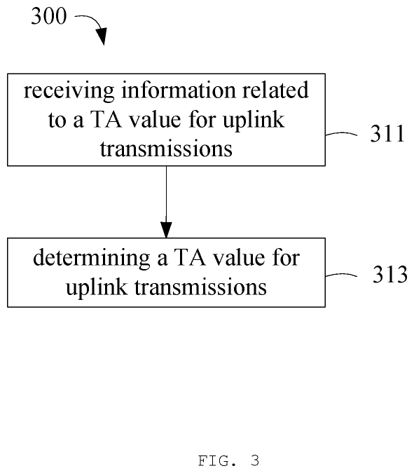

FIG. 3 illustrates a flow chart of an exemplary procedure 300 for determining a TA value according to some embodiments of the present disclosure. Details described in all of the foregoing embodiments of the present disclosure are applicable for the embodiments shown in FIG. 3. The procedure 300 may be performed by an IAB node.

Referring to FIG. 3, in operation 311, an IAB node (e.g., IAB node 120C in FIG. 1) may receive information related to a TA value for uplink transmissions from its parent node (e.g., IAB node 120B in FIG. 1). In some embodiments of the present disclosure, the information may be received via a MAC CE signaling. In operation 313, the IAB node may determine a TA value (e.g., TA_2,3,7) for uplink transmissions based on the information.

In some embodiments of the present disclosure, the information may indicate a propagation delay associated with a link between the grandparent node (e.g., IAB node 120A in FIG. 1) of the IAB node and the parent node (e.g., IAB node 120B in FIG. 1) of the IAB node. For example, a plurality of propagation delay values may be configured or predefined at the IAB node. The information may indicate a propagation delay value from the plurality of propagation delay values. The IAB node may determine the TA value for uplink transmissions based on the information and the plurality of propagation delay values.

In some embodiments of the present disclosure, the IAB node (e.g., IAB node 120C in FIG. 1) may further receive an indication (denoted as “μ”) of a sub-carrier space (SCS) associated with the link between the grandparent node (e.g., IAB node 120A in FIG. 1) of the IAB node and the parent node (e.g., IAB node 120B in FIG. 1) of the IAB node. In some embodiments of the present disclosure, the indication of the SCS may be received via a radio resource control (RRC) signaling or a MAC CE signaling. The IAB node may determine the TA value for uplink transmissions further based on the indication of the SCS.

For example, “μ=0” may indicate a SCS of 15 kHz, “μ=1” may indicate a SCS of 30 kHz, “μ=2” may indicate a SCS of 60 kHz, and “μ=3” may indicate a SCS of 120 kHz. The relationship between the propagation delay value and the SCS may be represented as: “the propagation delay value=i×16×64/2^{μ},” wherein i may be 0, 1, 2, . . . , or 3846 and is indicated in the receive information related to a TA value (hereinafter referred to as “the index in the information”).

In some embodiments of the present disclosure, the IAB node (e.g., IAB node 120C in FIG. 1) may implicitly determine the SCS associated with the link between the grandparent node (e.g., IAB node 120A in FIG. 1) of the IAB node and the parent node (e.g., IAB node 120B in FIG. 1) of the IAB node. In some examples, the IAB node may determine the SCS based on a frequency band associated with the link between the grandparent node of the IAB node and the parent node of the IAB node. In an example, the IAB node may determine that the SCS for frequency range 1 (FR1) is 15 kHz, and the SCS for frequency range 2 (FR2) is 60 kHz. The IAB node may determine the TA value for uplink transmissions further based on the determined SCS.

For example, the relationship between the propagation delay value and the SCS may be represented as: “the propagation delay value=i×16×64/ 2^{μ},” wherein i may be 0, 1, 2, . . . , or 3846 and is the index in the information, and the value of μ is based on the SCS determined by the IAB mode. For example, “μ=0” may indicate a SCS of 15 kHz, “μ=1” may indicate a SCS of 30 kHz, “μ=2” may indicate a SCS of 60 kHz, and “μ=3” may indicate a SCS of 120 kHz.

Based on the above descriptions, an IAB node may determine different TA values in different timing cases (e.g., as shown in FIG. 2, TA_2,3,1 for case #1, TA_2,3,6 for case #6, and TA_2,3,7 for case #7). While all of the timing cases (i.e., corresponding to a plurality of TA values) may be supported in a network, a specific timing case may be adopted at a certain time instance based on, for example, a scheduling decision and traffic status. This means that for a certain UL transmission, an IAB node may be indicated to adopt a specific timing case. Also, for different timing cases, different TA value determination or selection methods may be employed.

Embodiments of the present application further provide solutions to indicate time instances to adopt corresponding TA values. Some embodiments of the present application provide a semi-static TA value selection mechanism (may also be referred to as a periodic scheme). Some embodiments of the present application provide a dynamic TA value selection mechanism (may also be referred to as an aperiodic scheme). The two mechanisms can be used alone or in combination. More details on the embodiments of the present disclosure will be illustrated in the following text in combination with the appended drawings.

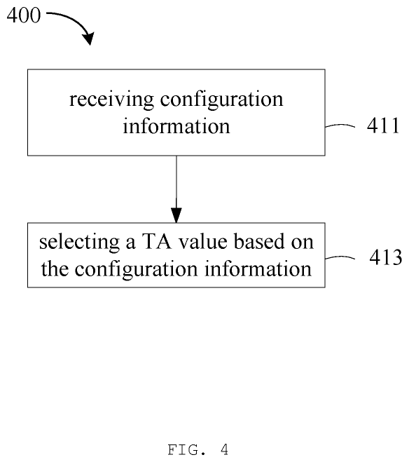

FIG. 4 illustrates a flow chart of an exemplary procedure 400 for selecting a TA value according to some embodiments of the present disclosure. Details described in all of the foregoing embodiments of the present disclosure are applicable for the embodiments shown in FIG. 4.

Referring to FIG. 4, in operation 411, an IAB node (e.g., IAB node 120C in FIG. 1) may receive configuration information for selecting a TA value from a plurality of TA values (e.g., TA_2,3,1 for case #1, TA_2,3,6 for case #6, and TA_2,3,7 for case #7 as shown in FIG. 2). In operation 413, the IAB node may select a TA value to be applied to uplink transmissions from the plurality of TA values based on the configuration information. In some embodiments of the present application, the configuration information may be configured per cell or per TA group (TAG).

In some embodiments of the present application, the exemplary procedure 400 is associated with a semi-static TA value selection mechanism. For example, a periodic pattern may be configured for each TA value of a plurality of TA values. For instance, the configuration information for selecting a TA value may indicate at least one of a periodicity, offset, and duration for each TA value of the plurality of TA values. In some embodiments of the present application, the periodic pattern (e.g., the configuration information) may be configured via an RRC signaling.

In these some embodiments, the configured TA value may only be applicable to an UL transmission(s) (e.g., a time domain resource such as an UL symbol(s)) in the corresponding duration. For an overlapped symbol(s) or slot(s) due to the change of TA values, the previous symbol or slot may have a higher priority. Moreover, when no periodic TA value is indicated for a time domain resource for uplink transmission, the latest TA value may be applied at the time domain resource for the uplink transmission.

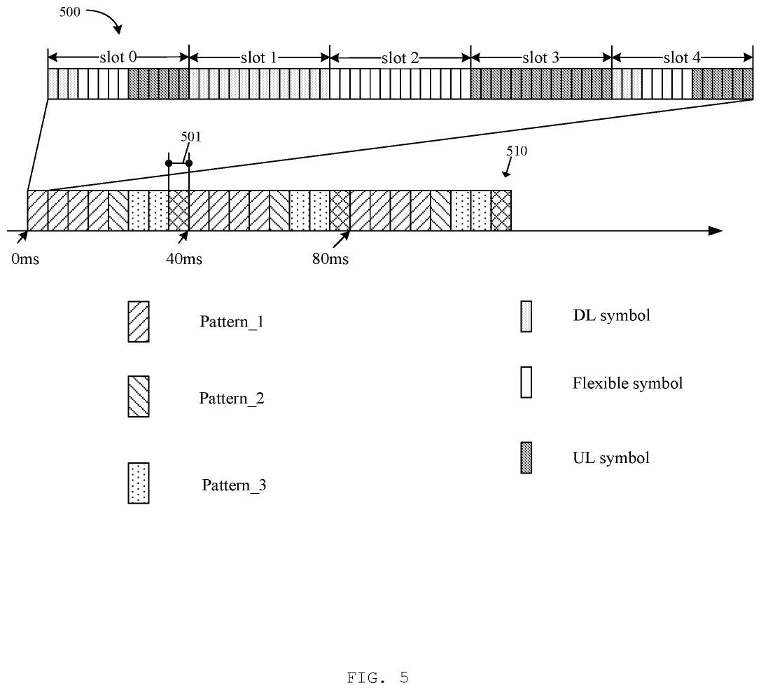

FIG. 5 illustrates an exemplary periodic TA value selection scheme 500 according to some embodiments of the present disclosure. Details described in all of the foregoing embodiments of the present disclosure are applicable for the embodiments shown in FIG. 5. In FIG. 5, the SCS is assumed to be 15 kHz as an example. It should be appreciated by persons skilled in the art that the SCS could be any other supported value.

Referring to FIG. 5, an IAB node may support three TA values for UL transmission. In some examples, the three TA values may be TA_1=20 μs for case #1 UL Tx timing, TA_2=10 μs for case #6 UL Tx timing, and TA_3=−5 μs for case #7 UL Tx timing. The IAB node may be configured with a respective periodic pattern for each TA value.

For example, the IAB node may be configured with a pattern_1 for TA_1, a pattern_2 for TA_2, and a pattern_3 for TA_3. As shown at 510 of FIG. 5, pattern_1 for TA_1 may have a periodicity of 40 ms, an offset of 0 ms, and duration of 20 ms. Pattern_2 for TA_2 may have a periodicity of 40 ms, an offset of 20 ms, and duration of 5 ms. Pattern_3 for TA_3 may have a periodicity of 40 ms, an offset of 25 ms, and duration of 10 ms.

Under such configuration, for every 40 ms, 0-19 ms of a respective 40 ms may be associated with case #1, and can be used for TDM between, for example, link 140-1 and link 140-2 as shown in FIG. 1; 20 ms-24 ms of a respective 40 ms may be associated with case #6, and can be used for SDM/FDM between, for example, link 140-2 and link 140-3 as shown in FIG. 1; and 25 ms to 34 ms of a respective 40 ms may be associated with case #7, and can be used for SDM/FDM between link 140-1 and link 140-2.

For the time duration 35 -39 ms (e.g., at 501 in FIG. 5) of a respective 40 ms, the TA value for UL transmission can be based on a default TA value (e.g., one of the TA values supported by the IAB node or another TA value) or the nearest TA value, or can be determined based on aperiodic signaling, which will be described in the following text. For example, the default TA value may be one of the TA values supported by the IAB node. In the example of FIG. 5, the nearest TA value may be TA_3.

In this way, the IAB node would know the TA value to be applied to a UL transmission. For example, as shown in FIG. 5, pattern_1 is configured for slot 0 to slot 4. Therefore, for UL symbols in slot 0 to slot 4, the IAB node may adopt TA_1 (e.g., 20 μs for case #1 UL Tx timing).

Referring back to FIG. 4, in some embodiments of the present application, the exemplary procedure 400 is associated with a dynamic TA value selection mechanism. In some embodiments of the present application, the dynamic TA value selection mechanism may only be applied to a time domain resource when no periodic TA value is indicated for the time domain resource.

In some examples, an IAB node may receive the configuration information for selecting a TA value via a RRC signaling or a MAC CE signaling. In the case that three timing cases are supported at the IAB node, two bits may be included in the RRC signaling or the MAC CE signaling to indicate one of the three timing cases (e.g., three TA values). In some embodiments of the present application, the indicated or selected TA value may be applied after an application delay indicated by the RRC signaling or MAC CE signaling.

In some other examples, an IAB node may receive the configuration information for selecting a TA value via group-common downlink control information (DCI), for example, DCI format 2_0, DCI format 2_5, etc. In these examples, in some embodiments of the present application, the indicated or selected TA value may be applied at the same slot as the group common DCI. In some other embodiments of the present application, the IAB node may receive a RRC signaling or a MAC CE signaling, and may apply the selected TA value after an application delay indicated by the RRC signaling or MAC CE signaling.

In some embodiments of the present application, the configuration information may be indicated by a reserved slot format index in the group-common DCI. For example, in a group-common DCI, 8 bits may be allocated for indicating slot format indexes, and thus can indicate 28 (256) slot formats. However, only a part (e.g., 56) of the 256 slot formats indexes may be standardized, and the remaining slot format indexes are reserved. Some of these reserved slot format indexes can be used for indicating the timing cases (e.g., TA values). In the case that three timing cases are supported at the IAB node, three slot format indexes may be used to indicate one of the three timing cases (e.g., three TA values).

In some other embodiments of the present application, the IAB node may receive a RRC signaling indicating a position in the group-common DCI. The position may be a starting position of bits for the configuration information in the group-common DCI. For example, the configuration information may include 2 bits for indicating one of the three timing cases (e.g., three TA values), and the position indicated in the RRC signaling may indicate the location of the 2 bits in the DCI.

In yet other examples, an IAB node may receive the configuration information for selecting a TA value via a UE-specific DCI (or dynamic DCI, such as DCI format 0_0, DCI format 0_1, and DCI format 0_2). In some embodiments of the present application, a dedicated (new) field in the UE-specific DCI may be used to indicate one of the plurality of TA values. In the case that three timing cases are supported at the IAB node, a dedicated field of 2 bits in the DCI may be used to indicate one of the three timing cases (e.g., three TA values).

In these examples, in some embodiments of the present application, the IAB node may apply the indicated or selected TA value after a delay indicated by the UE-specific DCI. When an uplink transmission scheduled by the UE-specific DCI precedes the application of the indicated TA value, the IAB node may apply a latest TA value for the uplink transmission scheduled by the UE-specific DCI. In some embodiments of the present application, the IAB node may apply the indicated TA value at a time domain resource when no periodic TA value is indicated for the time domain resource.

In some embodiments of the present application, the configuration information may be indicated by a time domain resource allocation field (or a time domain resource assignment field) in the UE-specific DCI. A new column may be added to a time domain resource allocation table to indicate the TA selection.

For example, Table 1 below shows an exemplary time domain resource allocation table from the 3GPP specification for NR systems. Table 1A below shows an updated table by adding a new column to indicate the TA selection in an IAB network. It should be understood that Table 1 and Table 1A are only for illustrative purposes, and should not be construed as limiting the embodiments of the present disclosure.

TABLE 1
Default physical uplink shared channel (PUSCH) time domain
resource allocation A for normal cyclic prefix (CP)

| | PUSCH | | | |
|---|---|---|---|---|
| Row index | mapping type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

TABLE 1A
Default PUSCH time domain resource allocation A for normal CP

| | PUSCH | | | | |
|---|---|---|---|---|---|
| Row index | mapping type | K₂ | S | L | TA type |
| 1 | Type A | j | 0 | 14 | TA value associated |
| | | | | | with Case #1 |
| 2 | Type A | j | 0 | 12 | TA value associated |
| | | | | | with Case #6 |
| 3 | Type A | j | 0 | 10 | TA value associated |
| | | | | | with Case #7 |
| 4 | Type B | j | 2 | 10 | TA value associated |
| | | | | | with Case #1 |
| 5 | Type B | j | 4 | 10 | TA value associated |
| | | | | | with Case #1 |
| 6 | Type B | j | 4 | 8 | TA value associated |
| | | | | | with Case #6 |
| 7 | Type B | j | 4 | 6 | TA value associated |
| | | | | | with Case #7 |
| 8 | Type A | j + 1 | 0 | 14 | TA value associated |
| | | | | | with Case #1 |
| 9 | Type A | j + 1 | 0 | 12 | TA value associated |
| | | | | | with Case #6 |
| 10 | Type A | j + 1 | 0 | 10 | TA value associated |
| | | | | | with Case #7 |
| 11 | Type A | j + 2 | 0 | 14 | TA value associated |
| | | | | | with Case #1 |
| 12 | Type A | j + 2 | 0 | 12 | TA value associated |
| | | | | | with Case #6 |
| 13 | Type A | j + 2 | 0 | 10 | TA value associated |
| | | | | | with Case #7 |
| 14 | Type B | j | 8 | 6 | TA value associated |
| | | | | | with Case #1 |
| 15 | Type A | j + 3 | 0 | 14 | TA value associated |
| | | | | | with Case #1 |
| 16 | Type A | j + 3 | 0 | 10 | TA value associated |
| | | | | | with Case #7 |

Compared to Table 1, the last column on the right of Table 1A indicates the TA type related to the TA selection at an IAB node. The time domain resource allocation field in the DCI may correspond to the row index in the above two tables.

For example, a time domain resource allocation field indicating “0111” corresponds to row index of “8.” K₂ refers to the delay between a physical downlink control channel (PDCCH) and the scheduled PUSCH, and j is determined by the SCS. For example, when the SCS is 15 kHz, the value of j is “1.” In this case, when the row index is “8,” K₂=j+1=2. PUSCH mapping type denotes whether the PUSCH mapping starts from the slot boundary. Type A means that it starts from the slot boundary and Type B means that it can start at any symbol. For example, when row index is “8,” the PUSCH mapping starts from the slot boundary. S corresponds to a starting position of a PUSCH. For example, when row index is “8,” the starting position of the PUSCH is symbol #0, i.e., the slot boundary. L corresponds to the length of the PUSCH, e.g., how many symbols are occupied by the PUSCH. For example, when row index is “8,” the length of the PUSCH is 14 symbols. In Table 1A, the TA type indicates the TA value to be adopted at an IAB node. For example, when row index is “8,” the IAB node may adopt the TA value associated with Case #1, for example, TA_2,3,1 shown in FIG. 2.

In some embodiments of the present application, the configuration information may be indicated by a bandwidth part (BWP) indicator field in the UE-specific DCI. For example, the TA selection and BWP indicator may be jointly coded. Different BWPs may be associated with different TA values. The reason is that a BWP selection restriction may be necessary when FDM is adopted between adjacent hops.

For example, Table 2 below shows an exemplary BWP indicator table from the 3GPP specification for NR systems. Table 2A below shows an enhanced BWP indicator table by adding a new column to indicate the TA selection in an IAB network. In this way, the BWP indicator field can indicate both the BWP ID and the TA type. It should be understood that Table 2 and Table 2A are only for illustrative purposes, and should not be construed as limiting the embodiments of the present disclosure.

TABLE 2
Bandwidth part indicator

| Value of BWP | |
|---|---|
| indicator field | |
| 2 bits | Bandwidth part |
| 00 | Configured BWP with BWP Id = 1 |
| 01 | Configured BWP with BWP Id = 2 |
| 10 | Configured BWP with BWP Id = 3 |
| 11 | Configured BWP with BWP Id = 4 |

TABLE 2A
Bandwidth part indicator

| Value of BWP | | |
|---|---|---|
| indicator field | | |
| 2 bits | Bandwidth part | TA type |
| 00 | Configured BWP with | TA value associated |
| | BWP-Id = 1 | with Case #1 |
| 01 | Configured BWP with | TA value associated |
| | BWP-Id = 2 | with Case #1 |
| 10 | Configured BWP with | TA value associated |
| | BWP-Id = 3 | with Case #6 |
| 11 | Configured BWP with | TA value associated |
| | BWP-Id = 4 | with Case #7 |

Compared to Table 2, the last column on the right of Table 2A indicates the TA type related to the TA selection at an IAB node. The BWP indicator indicates on which BWP the scheduled the PUSCH is transmitted. For example, in both tables, when the BWP indicator indicates “01,” the scheduled PUSCH should be transmitted on a BWP having a BWP ID of “2.” In Table 2A, when the BWP indicator indicates “01,” the IAB node may adopt the TA value associated with Case #1, for example, TA_2,3,1 shown in FIG. 2.

In some embodiments of the present application, the configuration information may be indicated by an antenna port field in the UE-specific DCI. For example, the TA selection and demodulation reference signal (DMRS) port index may be jointly coded. The reason is that a DMRS port selection restriction may be necessary when SDM is adopted between adjacent hops.

For example, Tables 3, 4, 5, and 6 below show exemplary antenna port tables from the 3GPP specification for NR systems. Tables 3A, 4A, 5A, and 6A below show enhanced antenna port tables by respectively adding a new column to indicate the TA selection in an IAB network. In this way, the antenna port field can indicate both the DMRS port and the TA type. It should be understood that the tables below are only for illustrative purposes, and should not be construed as limiting the embodiments of the present disclosure.

TABLE 3
Antenna port(s), transform precoder is disabled,
dmrs-Type = 1, maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

TABLE 4
Antenna port(s), transform precoder is disabled,
dmrs-Type = 1, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

TABLE 5
Antenna port(s), transform precoder is disabled,
dmrs-Type = 1, maxLength = 2, rank = 3

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

TABLE 6
Antenna port(s), transform precoder is disabled,
dmrs-Type = 1, maxLength = 2, rank = 4

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

TABLE 3A
Antenna port(s), transform precoder is disabled,
dmrs-Type = 1, maxLength = 2, rank = 1

| | Number of DMRS | | Number of | |
|---|---|---|---|---|
| | CDM group(s) | DMRS | front-load | |
| Value | without data | port(s) | symbols | TA type |
| 0 | 1 | 0 | 1 | TA value associated |
| | | | | with Case #1 |
| 1 | 1 | 1 | 1 | TA value associated |
| | | | | with Case #7 |
| 2 | 2 | 0 | 1 | TA value associated |
| | | | | with Case #1 |
| 3 | 2 | 1 | 1 | TA value associated |
| | | | | with Case #7 |
| 4 | 2 | 2 | 1 | TA value associated |
| | | | | with Case #6 |
| 5 | 2 | 3 | 1 | TA value associated |
| | | | | with Case #7 |
| 6 | 2 | 0 | 2 | TA value associated |
| | | | | with Case #1 |
| 7 | 2 | 1 | 2 | TA value associated |
| | | | | with Case #7 |
| 8 | 2 | 2 | 2 | TA value associated |
| | | | | with Case #6 |
| 9 | 2 | 3 | 2 | TA value associated |
| | | | | with Case #7 |
| 10 | 2 | 4 | 2 | TA value associated |
| | | | | with Case #1 |
| 11 | 2 | 5 | 2 | TA value associated |
| | | | | with Case #6 |
| 12 | 2 | 6 | 2 | TA value associated |
| | | | | with Case #1 |
| 13 | 2 | 7 | 2 | TA value associated |
| | | | | with Case #7 |
| 14-15 | Reserved | Reserved | Reserved | |

TABLE 4A
Antenna port(s), transform precoder is disabled,
dmrs-Type = 1, maxLength = 2, rank = 2

| | Number of DMRS | | Number of | |
|---|---|---|---|---|
| | CDM group(s) | DMRS | front-load | |
| Value | without data | port(s) | symbols | TA type |
| 0 | 1 | 0, 1 | 1 | TA value associated |
| | | | | with Case #1 |
| 1 | 2 | 0, 1 | 1 | TA value associated |
| | | | | with Case #1 |
| 2 | 2 | 2, 3 | 1 | TA value associated |
| | | | | with Case #7 |
| 3 | 2 | 0, 2 | 1 | TA value associated |
| | | | | with Case #1 |
| 4 | 2 | 0, 1 | 2 | TA value associated |
| | | | | with Case #1 |
| 5 | 2 | 2, 3 | 2 | TA value associated |
| | | | | with Case #7 |
| 6 | 2 | 4, 5 | 2 | TA value associated |
| | | | | with Case #1 |
| 7 | 2 | 6, 7 | 2 | TA value associated |
| | | | | with Case #6 |
| 8 | 2 | 0, 4 | 2 | TA value associated |
| | | | | with Case #1 |
| 9 | 2 | 2, 6 | 2 | TA value associated |
| | | | | with Case #1 |
| 10-15 | Reserved | Reserved | Reserved | |

TABLE 5A
Antenna port(s), transform precoder is disabled,
dmrs-Type = 1, maxLength = 2, rank = 3

| | Number of DMRS | | Number of | |
|---|---|---|---|---|
| | CDM group(s) | DMRS | front-load | |
| Value | without data | port(s) | symbols | TA type |
| 0 | 2 | 0-2 | 1 | TA value associated |
| | | | | with Case #1 |
| 1 | 2 | 0, 1, 4 | 2 | TA value associated |
| | | | | with Case #1 |
| 2 | 2 | 2, 3, 6 | 2 | TA value associated |
| | | | | with Case #7 |
| 3-15 | Reserved | Reserved | Reserved | |

TABLE 6A
Antenna port(s), transform precoder is disabled,
dmrs-Type = 1, maxLength = 2, rank = 4

| | Number of DMRS | | Number of | |
|---|---|---|---|---|
| | CDM group(s) | DMRS | front-load | |
| Value | without data | port(s) | symbols | TA type |
| 0 | 2 | 0-3 | 1 | TA value associated |
| | | | | with Case #1 |
| 1 | 2 | 0, 1, 4, 5 | 2 | TA value associated |
| | | | | with Case #1 |
| 2 | 2 | 2, 3, 6, 7 | 2 | TA value associated |
| | | | | with Case #7 |
| 3 | 2 | 0, 2, 4, 6 | 2 | TA value associated |
| | | | | with Case #1 |
| 4-15 | Reserved | Reserved | Reserved | |

Compared to Tables 3, 4, 5, and 6, the last column on the right of Tables 3A, 4A, 5A, and 6A the TA type related to the TA selection at an IAB node, respectively. In the above tables, “DMRS port(s)” refers to the DMRS port adopted by the scheduled PUSCH. “Number of frontloaded symbols” indicates whether a frontloaded DMRS (e.g., the first DMRS) occupies one or two symbols. “Number of DMRS CDM group(s) without data” indicates, on the time domain resource corresponding to the DMRS, the number of code division multiplexing (CDM) group that does not have any PUSCH.

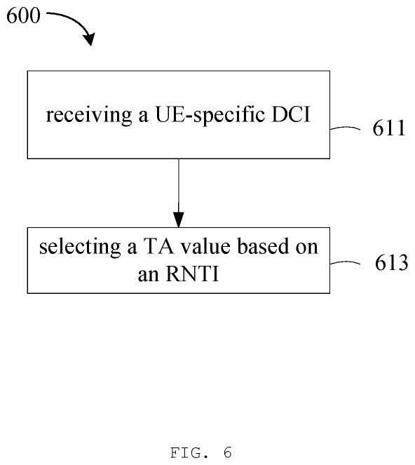

FIG. 6 illustrates a flow chart of an exemplary procedure 600 for selecting a TA value according to some embodiments of the present disclosure. Details described in all of the foregoing embodiments of the present disclosure are applicable for the embodiments shown in FIG. 6.

Referring to FIG. 6, in operation 611, an IAB node (e.g., IAB node 120C in FIG. 1) may receive a UE-specific DCI. The UE-specific DCI may be scrambled by a radio network temporary identity (RNTI). In operation 613, the IAB node may select a TA value to be applied to uplink transmissions from a plurality of TA values (e.g., TA_2,3,1 for case #1, TA_2,3,6 for case #6, and TA_2,3,7 for case #7 as shown in FIG. 2) based on the RNTI. In some embodiments of the present application, the configuration information may be configured per cell or per TA group (TAG).

In some embodiments of the present application, the selected TA value may be applied after a delay indicated by the UE-specific DCI. When an uplink transmission scheduled by the UE-specific DCI precedes the application of the selected TA value, the IAB node may apply a latest TA value for the uplink transmission scheduled by the UE-specific DCI. In some embodiments of the present application, the IAB node may apply the selected TA value at a time domain resource when no periodic TA value is indicated for the time domain resource.

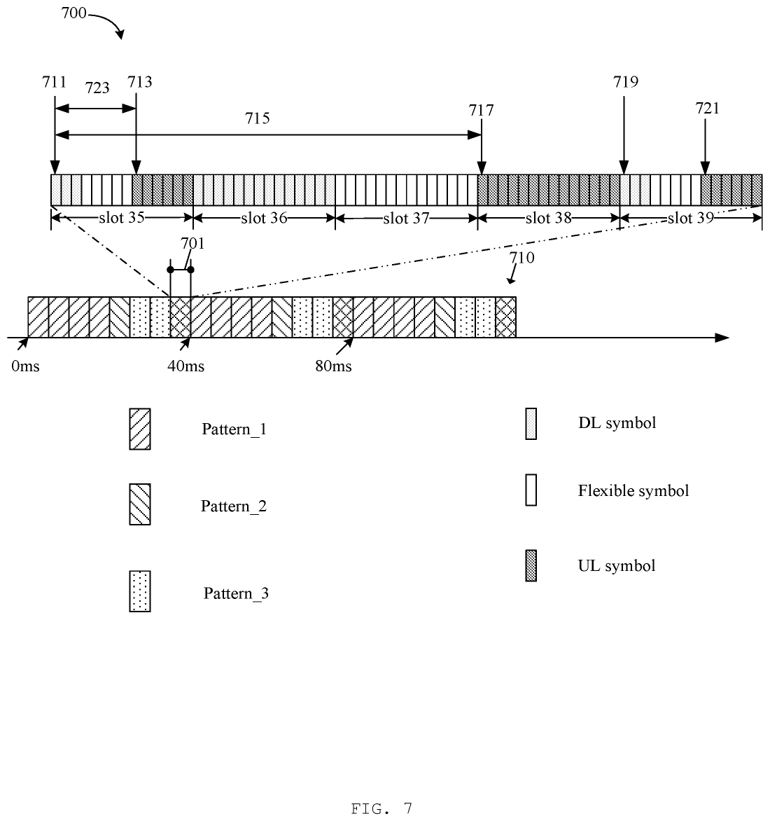

FIG. 7 illustrates an exemplary aperiodic TA value selection scheme 700 according to some embodiments of the present disclosure. Details described in all of the foregoing embodiments of the present disclosure are applicable for the embodiments shown in FIG. 7. In FIG. 7, the SCS is assumed to be 15 kHz as an example. It should be appreciated by persons skilled in the art that the SCS could be any other supported value.

Referring to FIG. 7, an IAB node (e.g., IAB node 120C in FIG. 1) may support three TA values for UL transmission. In some examples, the three TA values may be TA_1=20 μs for case #1 UL Tx timing, TA_2=10 μs for case #6 UL Tx timing, and TA_3=−5 μs for case #7 UL Tx timing. The IAB node may be configured with a respective periodic pattern for each TA value.

For example, the IAB node may be configured with a pattern_1 for TA_1, a pattern_2 for TA_2, and a pattern_3 for TA_3. As shown at 510 of FIG. 5, pattern_1 for TA_1 may have a periodicity of 40 ms, an offset of 0 ms, and duration of 20 ms. Pattern 2 for TA_2 may have a periodicity of 40 ms, an offset of 20 ms, and duration of 5 ms. Pattern_3 for TA_3 may have a periodicity of 40 ms, an offset of 25 ms, and duration of 10 ms.

Under such configuration, for every 40 ms, 0-19 ms of a respective 40 ms may be associated with case #1, and can be used for TDM between, for example, link 140-1 and link 140-2 as shown in FIG. 1; 20 ms-24 ms of a respective 40 ms may be associated with case #6, and can be used for SDM/FDM between, for example, link 140-2 and link 140-3 as shown in FIG. 1; and 25 ms to 34 ms of a respective 40 ms may be associated with case #7, and can be used for SDM/FDM between link 140-1 and link 140-2.

For the time duration 35-39 ms (e.g., at 701 in FIG. 7) of a respective 40 ms, the IAB node may be determine the TA value for UL transmission based on the aperiodic TA value indication signaling as described above with respect to FIGS. 4 and 6.

In some embodiments of the present application, the IAB node may apply the determined TA value after a delay indicated by the UE-specific DCI. In these embodiments, when an uplink transmission scheduled by the UE-specific DCI precedes the application of the determined TA value, the IAB node may apply a latest TA value for the uplink transmission scheduled by the UE-specific DCI.

For example, in some instances, the IAB node may use the scheduling delay in the UE-specific DCI as the delay for the determined TA value. For example, referring to FIG. 7, assuming that a UE-specific DCI indicating TA_2 is detected at 711 in slot 35, and the UE-specific DCI indicates a delay 715 (e.g., scheduling delay=2 slots+13 symbols), the IAB node may adopt TA_2 for UL transmission at 717.

In some other instances, the delay for the determined TA value may be different from the scheduling delay. For example, referring to FIG. 7, the UE-specific DCI detected at 711 may indicate a delay 723 (e.g., scheduling delay=8 symbols) for scheduling a PUSCH(s) and a delay 715 (e.g., application delay=2 slots+13 symbols) for the determined TA value. In this example, the IAB node would not adopt TA_2 indicated in the UE-specific DCI for UL transmission at 713 since TA_2 is not applicable until 717 according to the delay for the determined TA value. Instead, the IAB node would adopt the latest TA value (e.g., TA_3) for UL transmission at 713.

In some embodiments of the present application, the IAB node may apply the determined TA value at the same slot as the group-common DCI. For example, referring to FIG. 7, assuming that a group-common DCI indicating TA_3 is detected at 719, the IAB node may adopt TA_3 for UL transmission in slot 39. In the example of FIG. 7, the UL symbol in slot 39 starts at 721 (e.g., symbol 8 of slot 39), so TA_3 is adopted at 721. In some embodiments of the present application, an additional RRC signaling or MAC CE signaling may be employed to indicate the application delay of the TA value indicated in the group-common DCI.

In some embodiments of the present application, when no periodic TA value is indicated for a time domain resource for uplink transmission, the latest TA value (either a periodic or an aperiodic TA indication) may be applied at the time domain resource for the uplink transmission.

For example, referring to FIG. 7, an aperiodic TA indication at 711 may indicate the application of TA_2 for UL transmission at 713. No aperiodic or periodic TA value indication may be applied to UL transmission at 717. In this case, the IAB node would adopt the latest TA value (e.g., TA_2) for UL transmission at 717.

In some other embodiments of the present disclosure, the aperiodic TA value indication signaling may be applicable to the time domain resource with a periodic TA value indication. In these embodiments, the aperiodic TA value indication may have a higher priority than the periodic TA value indication.

In some other embodiments of the present disclosure, the aperiodic TA value indication signaling may not be applied to the time domain resource without a periodic TA value indication. In these embodiments, the latest TA value may be applied to the time domain resource for the uplink transmission. For example, assuming that no aperiodic TA value indication signaling is applied to the UL transmission resources in slots 35-39 shown in FIG. 7, the IAB node may adopt TA_3 for UL symbols at 713, 717 and 721.

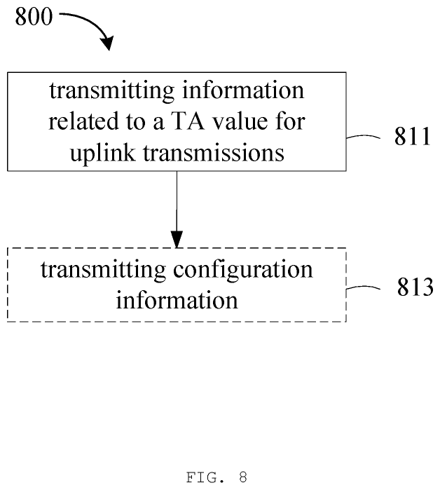

FIG. 8 illustrates a flow chart of an exemplary procedure 800 for determining a TA value according to some embodiments of the present disclosure. Details described in all of the foregoing embodiments of the present disclosure are applicable for the embodiments shown in FIG. 8. The procedure 800 may be performed by an IAB node.

Referring to FIG. 8, in operation 811, an IAB node (e.g., IAB node 120B in FIG. 1) may transmit information related to a TA value for uplink transmissions to its child node (e.g., IAB node 120C in FIG. 1). In some embodiments of the present disclosure, the information may be transmitted via a MAC CE signaling.

In some embodiments of the present disclosure, the information may indicate a propagation delay associated with a link between the IAB node and the parent node of the IAB node. In some embodiments of the present disclosure, the IAB node may further transmit an indication of a SCS associated with the link between the IAB node and the parent node of the IAB node. In some embodiments of the present disclosure, the indication of the SCS may be transmitted via a RRC signaling or a MAC CE signaling. Details regarding this indication are similar to those described with respect to FIG. 3, and thus are omitted herein.

In some embodiments of the present disclosure, the procedure 800 may further include operation 813 (denoted in dotted box as an option). In operation 813, the IAB node may transmit configuration information to its child node. The configuration information may be used for selecting a TA value to be applied to uplink transmissions at the child node from a plurality of TA values.

The configuration information may be associated with an aperiodic TA indication or a periodic TA indication. Details regarding the aperiodic TA indication and the periodic TA indication described with respect to FIGS. 4-7 can apply here. For example, in some embodiments of the present disclosure, the configuration information may be configured per cell or per TA group (TAG).

In some embodiments of the present disclosure, the configuration information may indicate at least one of a periodicity, offset, and duration for each TA value of the plurality of TA values. The configuration information may be transmitted via a RRC signaling.

In some embodiments of the present disclosure, the configuration information may be transmitted via a RRC signaling or a MAC CE signaling.

In some embodiments of the present disclosure, the configuration information may be transmitted via group-common DCI. In some examples, the configuration information may be indicated by a reserved slot format index in the group-common DCI. In some examples, the IAB node may further transmit a RRC signaling indicating a position in the group-common DCI. The position may indicate a starting position of bits for the configuration information in the group-common DCI.

In some embodiments of the present disclosure, the configuration information may be transmitted via UE-specific DCI. In some examples, the configuration information may be included a dedicated field in the UE-specific DCI. In some examples, the configuration information may be indicated by a time domain resource allocation field in the UE-specific DCI. In some examples, the configuration information may be indicated by a bandwidth part (BWP) indicator field in the UE-specific DCI. In some examples, the configuration information may be indicated by an antenna port field in the UE-specific DCI.

In some embodiments of the present disclosure, the procedure 800 may not include operation 813. The IAB node may transmit a UE-specific DCI scrambled by a RNTI to its child node. The RNTI may be associated with a TA value of a plurality of TA values to be applied to uplink transmissions at the child node.

It should be appreciated by persons skilled in the art that the sequence of the operations in the above exemplary procedures may be changed and some of the operations in the above exemplary procedures may be eliminated or modified, without departing from the spirit and scope of the disclosure.

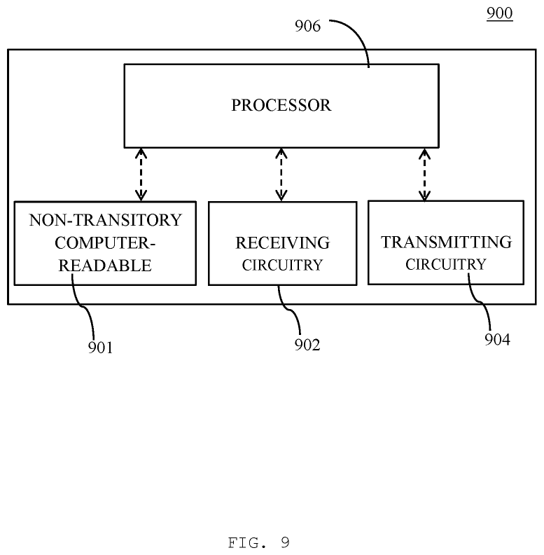

FIG. 9 illustrates a block diagram of an exemplary apparatus 900 according to some embodiments of the present disclosure.

As shown in FIG. 9, the apparatus 900 may include at least one non-transitory computer-readable medium 901, at least one receiving circuitry 902, at least one transmitting circuitry 904, and at least one processor 906 coupled to the non-transitory computer-readable medium 901, the receiving circuitry 902 and the transmitting circuitry 904.

Although in this figure, elements such as the at least one processor 906, transmitting circuitry 904, and receiving circuitry 902 are described in the singular, the plural is contemplated unless a limitation to the singular is explicitly stated. In some embodiments of the present application, the receiving circuitry 902 and the transmitting circuitry 904 are combined into a single device, such as a transceiver. In certain embodiments of the present application, the apparatus 900 may further include an input device, a memory, and/or other components.

In some embodiments of the present disclosure, the non-transitory computer-readable medium 901 may have stored thereon computer-executable instructions to cause a processor to implement the method with respect to the UE as described above. For example, the computer-executable instructions, when executed, cause the processor 906 interacting with receiving circuitry 902 and transmitting circuitry 904, so as to perform the operations with respect to the IAB node depicted in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including.”

1. A method, comprising:
receiving, from a second node at a third node, information related to a timing advance (TA) value for uplink transmissions, wherein the second node is a parent node of the third node; and
determining a first TA value for uplink transmissions based on the information.

2-6. (canceled)

7. The method according to claim 1, wherein the first TA value is one of a plurality of TA values, and the method further comprises:
receiving configuration information for selecting a TA value from a plurality of TA values; and
selecting the TA value to be applied to uplink transmissions from the plurality of TA values based on the configuration information.

8. The method according to claim 7, wherein the configuration information indicates at least one of a periodicity, offset, and duration for each TA value of the plurality of TA values.

9. The method according to claim 8, wherein the configuration information is received via a radio resource control (RRC) signaling.

10-46. (canceled)

47. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry, wherein the computer-executable instructions cause the at least one processor to:
receive, from a second node at a third node, information related to a timing advance (TA) value for uplink transmissions, wherein the second node is a parent node of the third node; and
determine a first TA value for uplink transmissions based on the information.

48. (canceled)

49. The apparatus according to claim 47, wherein the information indicates a propagation delay associated with a link between a first node and the second node, and wherein the first node is a parent node of the second node

50. The apparatus according to claim 47, wherein the information is received via a medium access control (MAC) control element (CE) signaling.

51. The apparatus according to claim 49, wherein the computer-executable instructions cause the at least one processor to:
receive an indication of a sub-carrier space (SCS) associated with the link between the first node and the second node;
wherein the indication of the SCS is received via a radio resource control (RRC) signaling or a medium access control (MAC) control element (CE) signaling;
wherein the first TA value for uplink transmissions is determined further based on the indication of the SCS.

52. The apparatus according to claim 47, wherein the first TA value is one of a plurality of TA values, and the computer-executable instructions further cause the at least one processor to:
receive configuration information for selecting a TA value from a plurality of TA values, wherein the configuration information indicates at least one of a periodicity, offset, and duration for each TA value of the plurality of TA values; and
select the TA value to be applied to uplink transmissions from the plurality of TA values based on the configuration information.

53. The apparatus of claim 52, wherein the configuration information indicates at least one of a periodicity, offset, and duration for each TA value of the plurality of TA values.

54. The apparatus of claim 53, wherein the configuration information is received via a radio resource control (RRC) signaling.

55. The apparatus of claim 52, wherein the configuration information is configured per cell or per TA group (TAG) and is received via a radio resource control (RRC) signaling or a medium access control (MAC) control element (CE) signaling.

56. The apparatus of claim 52, wherein:
the configuration information is received via group-common downlink control information (DCI);
the configuration information is indicated by a reserved slot format index in the group-common DCI; and
the computer-executable instructions further cause the at least one processor to:
receive a radio resource control (RRC) signaling or a medium access control (MAC) control element (CE) signaling, wherein the position is a starting position of bits for the configuration information in the group-common DCI.

57. The apparatus according to claim 47, wherein the first TA value is one of a plurality of TA values, and the computer-executable instructions further cause the at least one processor to:
receive a user equipment (UE)-specific downlink control information (DCI) scrambled by a radio network temporary identity (RNTI); and
select a TA value to be applied to uplink transmissions from the plurality of TA values based on the RNTI.

58. The apparatus according to claim 52, wherein: the configuration information is received via user equipment (UE)-specific downlink control information (DCI); and the configuration information is included in a dedicated field in the UE-specific DCI.

59. The apparatus according to claim 56, and the computer-executable instructions further cause the at least one processor to:
receive a radio resource control (RRC) signaling or a medium access control (MAC) control element (CE) signaling;
apply the TA value after an application delay indicated by one of the RRC signaling or MAC CE signaling; and
apply the TA value at the same slot as the group common DCI.

60. The apparatus according to claim 56, and the computer-executable instructions further cause the at least one processor to:
apply the TA value at a time domain resource when no periodic TA value is indicated for the time domain resource.

61. The apparatus according to claim 47, and the computer-executable instructions further cause the at least one processor to:
when no periodic TA value is indicated for a time domain resource for uplink transmission, apply a latest TA value at the time domain resource for the uplink transmission.

62. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry, wherein the computer-executable instructions cause the at least one processor to:
transmit, from a second node to a third node, information related to a timing advance (TA) value for uplink transmissions at the third node, wherein the second node is a parent node of the third node.

63. The apparatus according to claim 57, wherein the computer-executable instructions cause the at least one processor to:
transmit, via one of a radio resource control (RRC) signaling or a medium access control (MAC) control element (CE) signaling to the third node, configuration information for selecting a TA value to be applied to uplink transmissions at the third node from a plurality of TA values, wherein the configuration information indicates at least one of a periodicity, offset, and duration for each TA value of the plurality of TA values.
